(19) United States
(12) Patent Application Publication
(10) Pub. No.: US 2006/0171311 A1
(43) Pub. Date: Aug. 3, 2006

(54) Method and system for classifying packets

(75) Inventors: Chickayya Naik, San Jose, CA (US); Toerless Eckert, Mountain View, CA (US); Senthilkumar Krishnamurthy, Santa Clara, CA (US)

Correspondence Address: Trellis Intellectual Property Law Group, PC, 1900 EMBARCADERO ROAD, SUITE 109, PALO ALTO, CA, 94303, US

(73) Assignee: Cisco Technology, Inc., San Jose, CA (US)

(21) Appl. No.: 11/050,380

(22) Filed: Feb. 3, 2005

(51) Int. Cl. H04L 12/26; H04L 1/00; H04J 3/22; H04J 3/16

(52) U.S. Cl. 370/229; 370/465

(57) ABSTRACT

Methods and systems are provided for managing network traffic in a network device, based on matching criteria. The method includes providing a plurality of objects associated with a packet of the network traffic. A set of criteria corresponding to the type of objects and corresponding to the layer-4 protocol is created. A packet is accepted if the plurality of objects matches the set of criteria.

### BACKGROUND OF THE INVENTION

1. Field of Invention

This invention relates in general to managing network traffic in a network device. More specifically, the invention relates to methods and systems for classifying packets, based on layer-4 parameters.

2. Description of the Background Art

Network devices such as routers are typically used to manage network traffic in a network. Modular Quality of Service Command Line Interface (MQC) is a framework that provides a separation between the specification of a classification policy and the specification of other policies. The specification of a classification policy includes the definition of traffic classes. The specification of other policies includes drop, accept and log. MQC is used to enable Quality of Service (QoS) functionality. The steps required to configure a QoS policy with MQC are defining traffic classes, associating policies with each class of traffic, and attaching policies to interfaces (logical or physical). Each of the above steps is carried out by using a user interface command. Defining the traffic classes includes defining sets of match criteria that are checked for every packet. The current sets of criteria are based on the layer-3 Internet Protocol (IP) packet header.

In a conventional system, the sets of criteria are based on layer-3 protocols. There are situations where QoS needs to be applied on control packets. In these situations, it is desirable to look beyond the layer-3 packet header. This is required to improve the efficiency of transferring the data over a network. Presently, there is no method of preventing control packets from being transferred to a destination device, i.e., there is no method of defining matching criteria, based on the characteristics of a destination device.

### SUMMARY OF THE EMBODIMENTS OF THE INVENTION

In one embodiment, the invention provides a method for managing network traffic in a network device. The method comprises (i) creating a set of criteria corresponding to a destination device, (ii) transmitting a packet having a plurality of objects, and (iii) accepting the packet if the plurality of objects match the set of criteria.

In another embodiment of the invention, a method is provided for managing network traffic in a network device. The network traffic comprises a plurality of packets with each packet comprising a plurality of objects. The method comprises (i) creating a set of criteria corresponding to a layer-4 header of the packet, and (ii) accepting the packet if the plurality of objects match the set of criteria.

In another embodiment, the invention provides a method for managing network traffic in a network device. The network traffic comprises a plurality of packets. Each of the packets comprises a plurality of objects. The method comprises (i) creating a set of criteria corresponding to a type of objects, (ii) creating a set of criteria corresponding to a destination device, (iii) transmitting a packet having a plurality of objects, and (iv) accepting the packet if the plurality of objects match the set of criteria corresponding to the destination device and the type of objects.

In another embodiment, the invention provides a system for managing network traffic in a network device. The network traffic comprises a plurality of packets. Each of the packets comprises a plurality of objects. The system comprises (i) means for creating a set of criteria based on layer-4 parameters, (ii) means for matching the packet objects to a set of criteria, and (iii) means for accepting the packet if the plurality of objects associated with the packet match the set of criteria.

In another embodiment, the invention provides a system for managing network traffic in a network device. The network traffic comprises a plurality of packets. Each of the packets comprises a plurality of objects. The system comprises (i) a criteria creator for creating a set of criteria based on layer-4 parameters, (ii) a criteria matcher for matching the packet objects to the set of criteria, and (iii) a packet acceptor for accepting the packet if the plurality of objects associated with it match the set of criteria.

In further embodiments, the present invention provides an apparatus for managing network traffic in a network device. The network traffic comprises a plurality of packets with each packet includes a plurality of objects. The apparatus comprises a processing system including a processor coupled to a display and user input device; and a machine-readable medium including instructions executable by the processor comprising (i) one or more instructions for creating a set of criteria corresponding to a destination device; and (ii) one or more instructions for accepting a packet if the plurality of objects match the set of criteria.

These provisions, together with various ancillary provisions and features that will become apparent to artisans skilled in the art, as the following description proceeds, are achieved by means of devices, assemblies, systems, and methods of embodiments of the present invention, various embodiments thereof being shown with reference to the accompanying drawings, by way of example only, wherein:

### BRIEF DESCRIPTION OF THE DRAWINGS

FIG. 1 illustrates a schematic diagram of the environment wherein a network device can be implemented, in accordance with an exemplary embodiment of the present invention.

FIG. 2 illustrates a schematic diagram of the network device, in accordance with an exemplary embodiment of the invention.

FIG. 3 illustrates a flow diagram of a method for managing packets in a network device, in accordance with an exemplary embodiment of the invention.

### DETAILED DESCRIPTION OF THE EMBODIMENTS OF THE INVENTION

The invention provides a method and system for managing network traffic in network devices, such as routers and network platforms. The traffic includes data and control packets. Each of the packets includes a plurality of objects. An object may be, by way of example only, source port(s), destination port(s), IP-address of requesting host, Mac-address of requesting host, input interface attached to the host, LAN address (vlan id) of the requestor, and MAX number of hosts per port. In addition the objects may also include properties that are specific to the protocol the user or operator is trying to control access for. By way of example, if the user or operator is trying to control access of multicast receivers that use IGMP protocol, some of the objects may be IP-address of the multicast group, source and channel-address of the multicast group, and MAX number of group per port.

In an embodiment, each of the incoming or outgoing packets may be classified on the basis of the characteristics of the destination device. For various embodiments of the invention, characteristics used for classifying packets would include values which the previously mentioned objects would posses. By way of example, the value for the object “IP-address of requestor” may 74.x.y.z, the value for the object “vlan ID” may be 200, and the value for the object “mac-address” may be 0000.1.1, etc.

The classification based on the destination device may be carried out using a layer-4 application specific header. A certain policy or action may be associated with each of the packet classes. For various embodiments of the invention, a policy or action associated with each of the packet classes may include, by way of example only, accept, deny, log, and limit. A network device, such as a router, receives a packet, classifies the packet based on the policies, and accordingly sends the packet to a destination device.

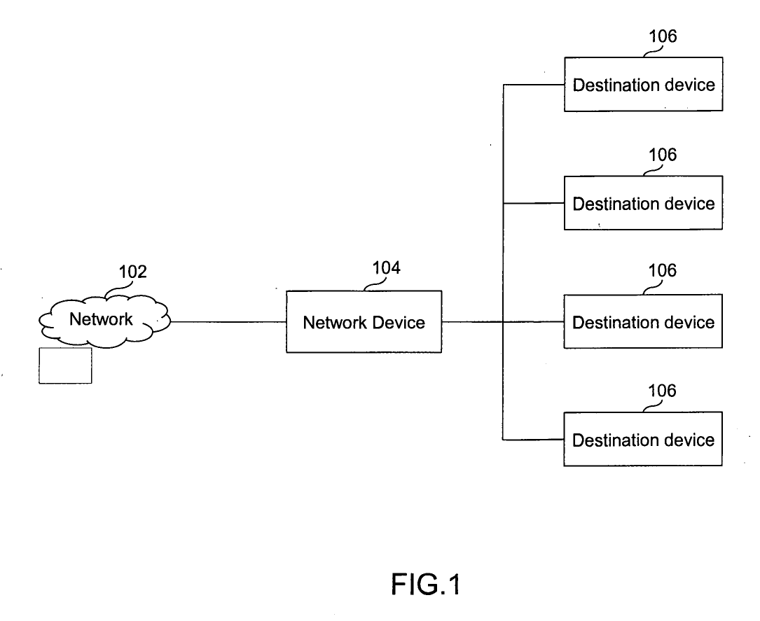

FIG. 1 illustrates a schematic diagram of the environment wherein a network device can be implemented, in accordance with an exemplary embodiment of the present invention. The environment comprises a network 102, a network device 104, and at least one destination device 106. Network 102 can be Internet, a set of computers connected to a network, for example, a Local Area Network (LAN), a Wide Area Network (WAN), and the like. Destination device 106 may be a personal computer, a PDA, or any other type of data-processing unit. In another embodiment, destination device 106 can be a part of a network, such as a LAN, WAN, and the like. Network 102 and destination device 106 exchange information via network device 104, in the form of packets, such as data packets and control packets, including Internet Group Management Protocol (IGMP) and Protocol Independent Multicast (PIM) packets.

Each of the packets may contain a plurality of objects. A packet generally refers to a unit of data, which can be of any protocol type. In an exemplary embodiment, a packet may be a Transmission Control Protocol (TCP) packet. The objects associated with the packet may be, for example as previously indicated, source and destination ports of the packet.

Network device 104 acts as an interface between network 102 and destination device 106. Network device 104 may be a router in various embodiments. Network device 104 receives the packets, classifies the packets based on a set of criteria, and appropriately transmits them to a destination device. In various embodiments, the user, such as a network administrator, provides the set of criteria. The packets are then matched against the set of criteria. If the packet objects match the specified criteria, the packet is sent to destination device 106.

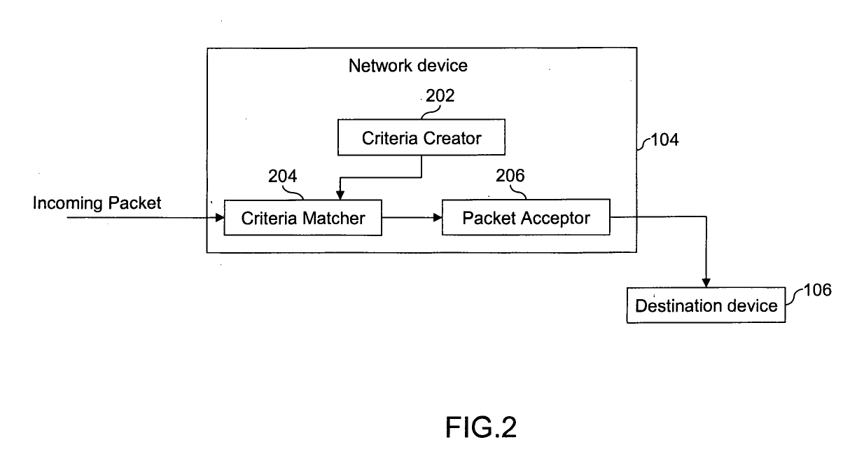

FIG. 2 illustrates a schematic diagram of network device 104, in accordance with an exemplary embodiment of the invention. Network device 104 includes a criteria creator 202, a criteria matcher 204, and a packet acceptor 206.

Criteria creator 202 is used to define the criteria, based on which the incoming packets may be classified. In various embodiments of the invention, the set of criteria corresponds to at least one packet field associated with a configuration of destination device 106. A user may input the criteria by using a class-map command. The class-map command is used to define a class of traffic as a named class that can be referred from multiple policy definitions. In one embodiment, the basic form of the class-map command may be:

class-map <class-map-name>

match <match-criteria>

A policy-map command may be used to represent a set of policies that are to be applied to a set of classes that are defined in the class-map. Exemplary policies include a maximum rate at which certain classes of packets are received and a minimum bandwidth associated with a class. In one embodiment of the invention, the basic form of the policy-map command may be:

policy-map <policy-map-name>

class <class-map-name-1>

<policy-1>
<policy-2>
. . .
<policy-n>

. . .
class <class-map-name-n>

<policy-1>
<policy-2>
<policy-n>

The set of criteria may be an access list, an input interface, an IP precedence and differentiated services code point, a source IP address, a destination IP address, a protocol, a mac-layer address, a QoS group, a VLAN, a packet length, and other protocol-specific criteria such as MPLS, ATM and dot1Q tags and the combinations thereof.

In addition to the above criteria, the user may also choose a set of criteria based upon the characteristics of destination device 106. The set of criteria, based on the characteristics of destination device 106, may be created by using the layer-4 protocol. The classification based on the layer-4 protocols, includes a classification based on, for example, a specific layer-4 TCP or User Datagram Protocol (UDP) destination and the source port numbers contained within the header of an IP frame. A specific port number or a range of port numbers may also be specified.

In an embodiment of the invention, a user may define the set of criteria, based upon destination device 106, by modifying the syntax of the class-map command. In one embodiment of the invention, the basic form of the modified class-map command may be:

class-map [type] <class-map-name>

match <match-criteria>

The ‘type’ of class-maps is used to match with the layer-4 application-specific header inside the packet payload, and to differentiate them from those criteria that match against packet header. The ‘type’ of the class-map in the class-map command, illustrated above, defines the semantic of the packet payload and how to interpret the requests. In one embodiment of the invention, if a ‘type’ is specified, the list of match criteria presented to the user would only be the criteria that are relevant for the packet objects being matched. For example, if the ‘type’ of the class-map is ‘igmp’, for matching against IGMP layer-4 headers, the relevant criteria may be as follows:

class-map igmp igmp-foo
match ?
reporter ip <acl>
reported mac <acl>
channel-group <acl>
vlan <vlan-id>
version <1|2|3>

In another embodiment of the invention, the ‘type’ of class-maps may be optional. If the ‘type’ has not been specified, the set of criteria may be used to match against packet headers.

When network device 104 receives a packet that is to be sent, criteria matcher 204 matches the packet objects with the set of criteria provided by criteria creator 202. If the objects match with the set of criteria, packet acceptor 206 accepts the packet. Packet acceptor 206 then sends the packet to destination device 106. Otherwise, packet acceptor 206 disallows the packet, and the packet is not sent to destination device 106.

In various embodiments, the invention is implemented within the Modular Quality of Service Command Line Interface (MQC) framework. Each of the modules of network device 104 can be implemented as a software module. Network device 104 can be implemented as a part of a processing system such as a computer.

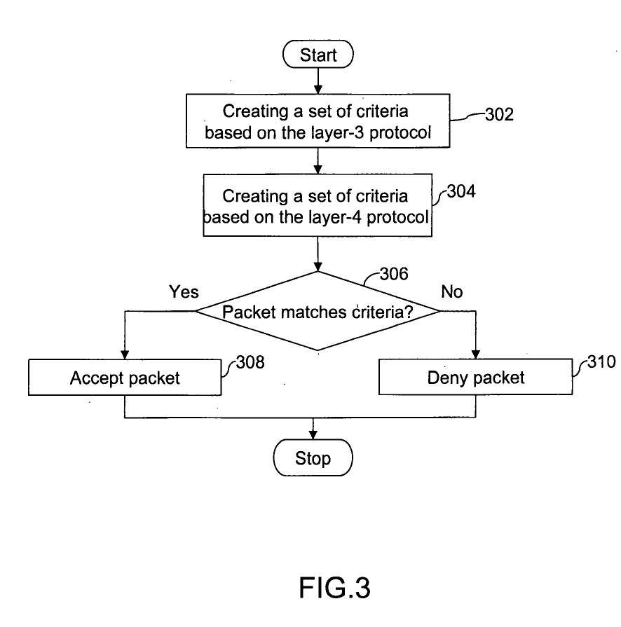

FIG. 3 illustrates a flow diagram of a method for managing packets in a network device, in accordance with an exemplary embodiment of the invention. At step 302, criteria creator 202 creates a set of criteria, based on the parameters associated with destination device 106. These parameters may correspond to layer-3 protocols. At step 304, criteria creator 202 creates a set of criteria, based on layer-4 protocols. At step 306, criteria matcher 204 matches the packet objects with the specified criteria. If the packet objects match the set of criteria, the packet is accepted, as shown in step 308, and sent to destination device 106. If the packet objects do not match the set of criteria, the packet is disallowed at step 310.

Embodiments of the present invention have the advantage that network traffic is managed more efficiently, since the basis of classification is more detailed. Therefore, the transfer of packets between network 102 and destination device 106 is more efficient. Another advantage is that in the case of the transfer of a large number of packets, the system protects device 104 from crashing. For example, the invention helps in preventing DOS attacks. DOS attacks exploit memory usage by creating a huge amount of protocol states on the router. This can be avoided by using the extended classification framework provided in the invention to authorize control packets.

Although the invention has been discussed with respect to specific embodiments thereof, these embodiments are merely illustrative and are not restricted to the invention. Any suitable programming language can be used to implement the routines of the present invention, including C, C++, Java, assembly language, etc. Different procedural or object-oriented programming techniques can be employed. The routines can be executed on a single processing device or on multiple processors. Although the steps, operations or computations may be presented in a specific order, this order may be changed in different embodiments. In some embodiments, multiple steps, shown as sequential in this specification, can be performed at the same time. The sequence of operations described herein can be interrupted, suspended or otherwise controlled by another process, such as an operating system, kernel, and so forth. The routines can operate in an operating system environment, or as stand-alone routines occupying all or a substantial part of system processing.

Also in the description herein for embodiments of the present invention, a portion of the disclosure recited in the specification contains material, which is subject to copyright protection. Computer program source code, object code, instructions, text or other functional information that is executable by a machine may be included in an appendix, tables, figures or in other forms. The copyright owner has no objection to the facsimile reproduction of the specification as filed in the Patent and Trademark Office. Otherwise all copyright rights are reserved.

In the description provided herein for embodiments of the present invention, numerous specific details are provided, such as examples of components and/or methods, to provide a thorough understanding of the embodiments of the present invention. One skilled in the relevant art will recognize, however, that an embodiment of the invention can be practiced without one or more of the specific details, or with other apparatuses, systems, assemblies, methods, components, materials, parts, and/or the like. In other instances, well-known structures, materials or operations are not specifically shown or described in detail, to avoid obscuring aspects of the embodiments of the present invention.

A ‘computer-readable medium’, for purposes of embodiments of the present invention, may be any medium that can contain, store, communicate, propagate or transport the program, to be used by or in connection with the instruction execution system, apparatus, system or device. The computer-readable medium can be, by way of example only but not by limitation, an electronic, magnetic, optical, electromagnetic, infrared or semiconductor system, apparatus, system, device, propagation medium or computer memory.

A ‘computer’ for purposes of embodiments of the present invention may include any processor-containing device, such as a mainframe computer, personal computer, laptop, notebook, microcomputer, server, personal data manager or ‘PIM’ (also referred to as a personal information manager), smart cellular or other phone, so-called smart card, set-top box, or any of the like. A ‘computer program’ may include any suitable locally or remotely executable program or sequence of coded instructions which are to be inserted into a computer, well known to those skilled in the art. Stated more specifically, a computer program includes an organized list of instructions that, when executed, causes the computer to behave in a predetermined manner. A computer program contains a list of ingredients (called variables) and a list of directions (called statements) that tell the computer what to do with the variables. The variables may represent numeric data, text, audio or graphical images. If a computer is employed for synchronously presenting multiple video program ID streams, such as on a display screen of the computer, the computer would have suitable instructions (e.g., source code) for allowing a user to synchronously display multiple video program ID streams in accordance with the embodiments of the present invention. Similarly, if a computer is employed for presenting other media via a suitable directly or indirectly coupled input/output (I/O) device, the computer would have suitable instructions for allowing a user to input or output (e.g., present) program code and/or data information respectively in accordance with the embodiments of the present invention.

A ‘processor’ or ‘process’ includes any human, hardware and/or software system, mechanism or component that processes data, signals or other information. A processor can include a system with a general-purpose central processing unit, multiple-processing units, dedicated circuitry for achieving functionality, or other systems. Processing need not be limited to a geographic location or have temporal limitations. For example, a processor can perform its functions in ‘real time,’ ‘offline,’ in a ‘batch mode,’ etc. Portions of processing can be performed at different times and different locations by different (or the same) processing systems.

Reference throughout this specification to “one embodiment”, “an embodiment”, or “a specific embodiment” means that a particular feature, structure or characteristic described in connection with the embodiment is included in at least one embodiment of the present invention, and not necessarily in all embodiments. Therefore, the appearance of the phrases “in one embodiment”, “in an embodiment”, or “in a specific embodiment” in various places throughout this specification does not necessarily refer to the same embodiment. Furthermore, the particular features, structures or characteristics of any specific embodiment of the present invention may be combined in any suitable manner with one or more other embodiments. It is to be understood that other variations and modifications of the embodiments of the present invention, described and illustrated herein, are possible in light of the teachings herein and are to be considered as part of the spirit and scope of the present invention.

Further, at least some of the components of an embodiment of the invention may be implemented by using a programmed general-purpose digital computer, by means of application-specific integrated circuits, programmable logic devices, field-programmable gate arrays; or by using a network of interconnected components and circuits. Connections may be wired, wireless, by modem, and so forth.

It will also be appreciated that one or more of the elements depicted in the drawings/figures can be implemented either in a separate or an integrated manner, or even removed or rendered inoperable in certain cases, as is useful, in accordance with a particular application.

Additionally, any signal arrows in the drawings/figures should be considered only as exemplary, and not limiting, unless otherwise specifically mentioned. Combinations of components or steps will also be considered as being noted, where the terminology renders unclear the ability to separate or combine.

As used in the description herein and throughout the claims that follow, ‘a’, ‘an’, and ‘the’ includes plural references, unless the context clearly dictates otherwise. Also, as used in the description herein and throughout the claims that follow, the meaning of ‘in’ includes ‘in’ as well as ‘on’, unless the context clearly dictates otherwise.

The foregoing description of the illustrated embodiments of the present invention, including what is described in the abstract, is not intended to be exhaustive or limit the invention to the precise forms disclosed herein. While specific embodiments and examples of the invention are described herein for illustrative purposes only, various equivalent modifications are possible within the spirit and scope of the present invention, as those skilled in the relevant art will recognize and appreciate. As indicated, these modifications may be made to the present invention, in light of the foregoing description of the illustrated embodiments of the present invention, and are to be included within the spirit and scope of the present invention.

Therefore, while the present invention has been described herein with reference to the particular embodiments thereof, latitude of modification and various changes and substitutions are intended in the foregoing disclosures. It will be appreciated that in some instances some features of the embodiments of the invention will be employed without the corresponding use of other features, without departing from the scope and spirit of the invention, as set forth. Therefore, many modifications may be made, to adapt a particular situation or material to the essential scope and spirit of the present invention. It is intended that the invention is not limited to the particular terms used in the following claims, and/or to the particular embodiment disclosed as the best mode contemplated for carrying out this invention. The invention will include any and all embodiments and equivalents falling within the scope of the appended claims.

What is claimed is:

1. A method for managing network traffic comprising:
creating a set of criteria corresponding to a destination device;
transmitting a packet having a plurality of objects; and
accepting the packet if the plurality of objects match the set of criteria.

2. The method of claim 1 wherein said creating and said accepting are within a network device.

3. The method in accordance with claim 2, wherein the network device comprises a router.

4. The method in accordance with claim 1, wherein the method is implemented in a Modular QoS CLI framework.

5. The method in accordance with claim 1, wherein the set of criteria are created using the layer 4 header of the packet.

6. The method in accordance with claim 5, wherein the packet comprises an IGMP packet.

7. The method in accordance with claim 5, wherein the packet comprises a PIM packet.

8. The method in accordance with claim 1, wherein the set of criteria corresponding to the type of objects comprises at least one of access list, input interface, IP precedence and differentiated services code point, protocol, QoS group and packet length.

9. A method for managing packets in a network device, comprising:
creating a set of criteria in a network device corresponding to a layer-4 header of a packet having a plurality of objects; and
accepting the packet by the network device if the plurality of objects match the set of criteria.

10. The method according to claim 9, wherein the network device comprises a router.

11. The method in accordance with claim 9, wherein the method is implemented in a Modular QoS CLI framework.

12. The method in accordance with claim 9, wherein the packet comprises an IGMP packet.

13. The method in accordance with claim 9, wherein the packet comprises a PIM packet.

14. The method in accordance with claim 9, wherein the set of criteria corresponding to the type of objects comprises at least one of access list, input interface, IP precedence and differentiated services code point, protocol, QoS group and packet length.

15. A method for managing network traffic in a network device, comprising:
creating a set of criteria corresponding to a type of objects;
creating a set of criteria corresponding to a destination device;
transmitting a packet having a plurality of objects; and
accepting the packet if the plurality of objects match the set of criteria corresponding to the destination device and the type of objects.

16. The method in accordance with claim 15, wherein the network device comprises a router.

17. The method in accordance with claim 15, wherein the method is implemented in a Modular QoS CLI framework.

18. The method in accordance with claim 15, wherein the set of criteria corresponding to the destination device are created by using a layer-4 header of the packet.

19. The method in accordance with claim 18, wherein the packet comprises an IGMP packet.

20. The method in accordance with claim 18, wherein the packet comprises a PIM packet.

21. The method in accordance with claim 15, wherein the set of criteria corresponding to the type of objects comprises at least one of access list, input interface, IP precedence and differentiated services code point, protocol, QoS group and packet length.

22. A system for managing network traffic in a network device wherein the network traffic includes a plurality of packets with each packet having a plurality of objects, the system comprising:
means for creating a set of criteria based on layer-4 parameters;
means for matching the set of criteria with objects associated with a packet; and
means for accepting the packet if the plurality of objects associated with the packet match the set of criteria.

23. The system in accordance with claim 22, wherein the network device comprises a router.

24. The system in accordance with claim 22, wherein the packet comprises an IGMP packet.

25. The system in accordance with claim 22, wherein the packet comprises a PIM packet.

26. A system for managing packets in a network device wherein the network traffic includes a plurality of packets with each packet having a plurality of objects, the system comprising:
a criteria creator for creating a set of criteria based on layer-4 parameters;
a criteria matcher for matching the objects associated with a packet to the set of criteria; and
a packet acceptor for accepting the packet if the plurality of objects associated with the packet match the set of criteria.

27. The system in accordance with claim 26, wherein the network device comprises a router.

28. The system in accordance with claim 26, wherein the packet comprises an IGMP packet.

29. The system in accordance with claim 26, wherein the packet comprises a PIM packet.

30. An apparatus for managing network traffic in a network device wherein the network traffic includes a plurality of packets with each packet having a plurality of objects, the apparatus comprising:
a processing system including a processor coupled to a display and user input device;
a machine-readable medium including instructions executable by the processor comprising
one or more instructions for creating a set of criteria corresponding to a destination device; and
one or more instructions for accepting a packet if the plurality of objects match the set of criteria.

31. A machine-readable medium including instructions executable by the processor comprising:
one or more instructions for creating a set of criteria corresponding to a destination device; and
one or more instructions for accepting a packet if the plurality of objects match the set of criteria.
